(19) United States
(12) Patent Application Publication
(10) Pub. No.: US 2008/0246169 A1
(43) Pub. Date: Oct. 9, 2008

(54) Filtering structure of a humidifier

(76) Inventor: Ping Huang, Yung Kang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,758

(22) Filed: Apr. 4, 2007

(51) Int. Cl. B01D 47/02

(52) U.S. Cl. 261/5

(57) ABSTRACT

A humidifier includes a water storage tank, and an air passage and a filtering device in the water storage tank; the filtering device has a hollow holding portion therein, and magnetic members held in the hollow holding portion, which will make metallic substances adhere to the hollow holding portion when water is flowing through the filtering device; the filtering device has an annular wall between the hollow holding portion and an outer wall thereof; the filtering device has a flow passage, which exists next to inner and outer sides of the annular wall, and which is stuffed with ion exchange resin for filtering out minerals; the filtering device having a water inlet on an outward edge of a lower end thereof, and a water outlet on an inward edge of the lower end; therefore, unfiltered water is prevented from flowing to the heater through the air passage.

### BACKGROUND OF THE INVENTION

1. Field of the Invention

The present invention relates to a filtering structure of a humidifier, more particularly one, which can filter out metallic substances as well as minerals, and prevent unfiltered water from directly flowing to a heating unit of the humidifier through an air passage, thus preventing remaining of filth and unwanted substances in the humidifier.

2. Brief Description of the Prior Art

In order to prevent people from being subjected to bad effects of very dry room air, which can be caused by use of air conditioners and heaters, humidifiers are developed. A common humidifier comprises a water storage tank, and a heater for heating water so as to produce steam, which will be immediately sent out to increase humidity of the room.

Referring to FIG. 6, a currently existing humidifier 4 includes a hollow containing member 41, a heater (not shown), and a filter 42. The hollow containing member 41 contains water, and it has a water discharge exit 411. The filter 42 is fitted on top of the water discharge exit 411, and it has a stuffed portion 43, an air passage 44, and a water inlet 45. The stuffed portion 43 is stuffed with ion exchange resin. The water inlet 45 allows water to flow from the hollow containing member 41 into the filter 42 through it. The air passage 44 is provided in a portion of the filter 42 that doesn't contain ion exchange resin. The air passage 44 has an air outlet portion 46, which communicates with outside of the filter 42, and has several vent holes 461. The air outlet portion 46 is as high as or above the water inlet 45. The vent holes 461 of the air outlet portion 46 is provided for limiting flow of liquid as well as help air inside the air passage 44 travel out of the filter 42.

When the humidifier 4 is activated, it will start heating water; thus, water is transformed into steam, and sent out into the atmosphere so as to increase humidity of the air. However, such a humidifier has the following disadvantages: first, the filter 42 only contains ion exchange resin for filtering out minerals from water therefore its performance isn't satisfactory; secondly, because the air passage, the air outlet portion and the vent holes exist on the filter, unfiltered water is prone to flow through the water discharge exit of the hollow holding member through the vent holes, the air outlet portion and the air passage when water is being poured into the hollow containing member of the humidifier. Consequently, filth will remain and accumulate on the heater and in water conduits of the humidifier, which is relatively difficult to clean away, after water has been boiled and transformed into steam. And, the user has to take the trouble to clean away the filth otherwise breakdown of the humidifier and blockage of the conduits are prone to happen. Therefore, there is still room for improvement.

### SUMMARY OF THE INVENTION

A humidifier according to an embodiment of the present invention includes a water storage tank, and an air passage and a filtering device in the water storage tank. The filtering device has an internal hollow holding portion, and magnetic members held in the hollow holding portion, which is used for making metallic substances contained in water adhere to the hollow holding portion The filtering device has an annular wall between the hollow holding portion and an outer wall thereof, and has a flow passage, which exists next to inner and outer sides of the annular wall, and which is stuffed with ion exchange resin for filtering out minerals The filtering device having a water inlet on an outward edge of a lower end thereof, and a water outlet on an inward edge of the lower end. Therefore, metallic substances and minerals can be filtered out, and unfiltered water is prevented from directly flowing to the heater through the air passage, and in turn no filth or unwanted substances will remain.

### BRIEF DESCRIPTION OF THE DRAWINGS

The present invention will be better understood by referring to the accompanying drawings, wherein:

FIG. 1 is a sectional view of the present invention,

FIG. 2 is a perspective sectional view of the filter of the invention,

FIG. 3 is a vertical sectional view of the filter of the invention,

FIG. 4 is an exploded perspective view of the second preferred embodiment of a filter of the present invention,

FIG. 5 is a horizontal section of the present invention in use, and

FIG. 6 is a partial sectional view of the prior art.

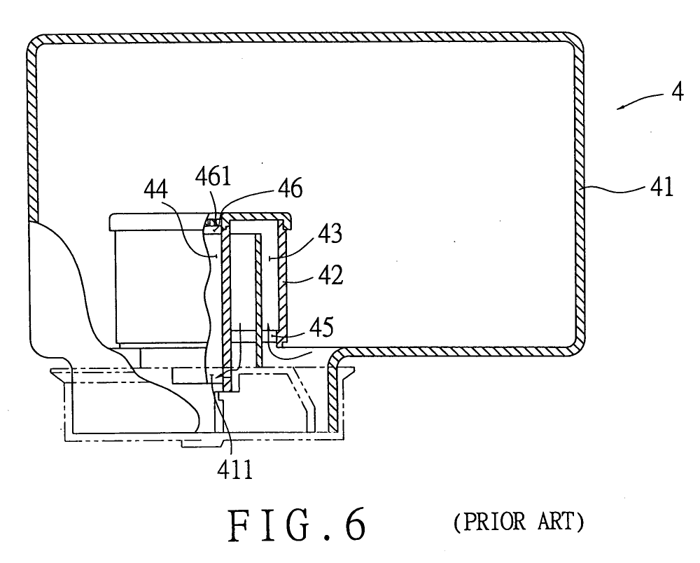

### DETAILED DESCRIPTION OF THE PREFERRED EMBODIMENTS

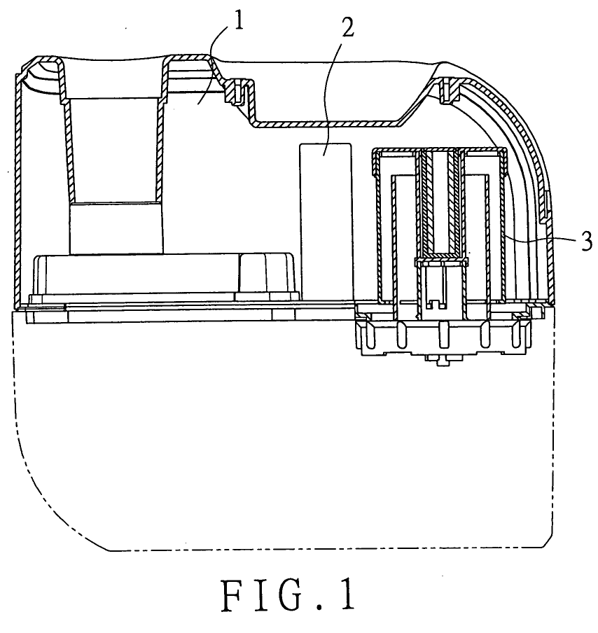

Referring to FIG. 1, a first preferred embodiment of a humidifier of the present invention includes a water storage tank 1, an air passage 2 in the water storage tank 1, and a filtering device 3.

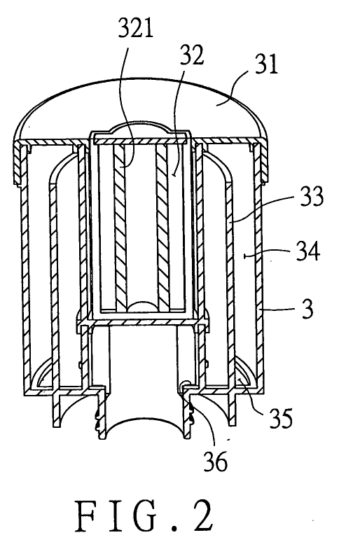

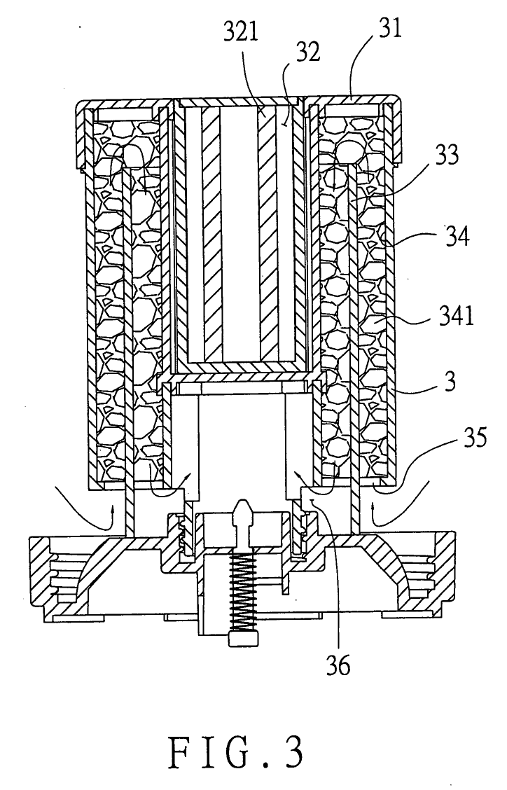

Referring to FIGS. 2 and 3 as well, the filtering device 3 has a covering part 31 on an upper end thereof, a hollow holding portion 32 therein, and several magnetic members 321 disposed in the hollow holding portion 32. The filtering device 3 has an annular wall 33 between the hollow holding portion 32 and an outer wall thereof. An upper end of the annular wall 33 is below and off the covering part 31. The filtering device 3 has a flow passage 34, which exist next to inner and outer sides of the annular wall 33. The flow passage 34 of the filtering device 3 is stuffed with ion exchange resin 341. The filtering device 3 further has a water inlet 35 on an outward edge of a lower end, and a water outlet 36 on an inward edge of the lower end.

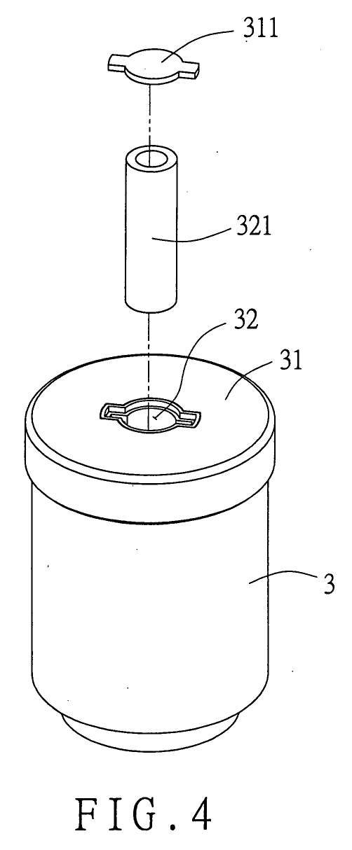

The covering part 31 of the first preferred embodiment is securely fitted on the filtering device 3 so as to seal the upper end of the filtering device 3. Referring to FIG. 4, an exploded perspective view of a second preferred embodiment of a filtering device 3, a covering part 31 of the second preferred embodiment further comprises a movable part 311 facing the hollow holding portion 32 so that the user is allowed to open the movable part 311, and change magnetic members 321 or other kinds of filters disposed inside the filtering device 3.

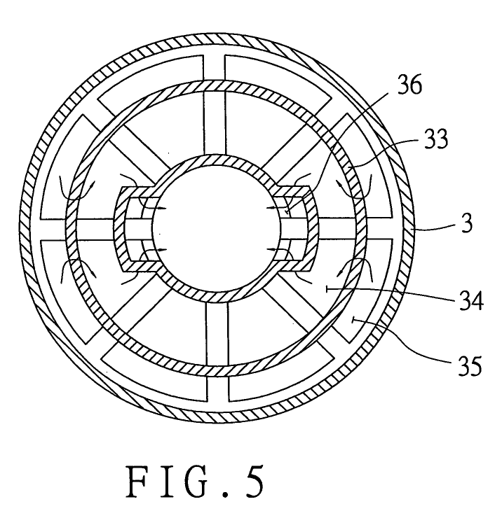

Referring to FIG. 5, owing to existence of the air passage 2 in the water storage tank 1, convection happens in the humidifier, and in turn water in the water storage tank 1 is made to flow into the flow passage 34 through the water inlet 35; thus, minerals contained in the water are filtered out by means of the ion exchange resin 341 in the flow passage 34. Furthermore, metallic substances contained in water will be made to adhere to the outer side of the hollow holding portion 32 by the magnetic members 321 disposed in the hollow holding portion 32 when water is flowing past the outer side of the hollow holding portion 32. Consequently, cleaned water, from which minerals and metallic substances have been filtered out, flow to outside through the water outlet 36 on the inward edge of the lower end of the filtering device 3.

From the above description, it can be seen that the present invention has the following advantages over the prior art: first, the air passage and the filtering device are separate in the water storage tank, unfiltered water is prevented from directly flowing to the heater through the air passage; secondly, the humidifier has the magnetic members in the hollow holding portion besides having the ion exchange resin in the flow passage therefore metallic substances and minerals contained in water will be filtered out, and there won't be filth and unwanted substances remaining, which would cause blockage of the conduits and breakdown of the humidifier.

What is claimed is:

1. A filtering structure of a humidifier, comprising
a filtering device, said filtering device having a hollow holding portion therein; said filtering device having a plurality of magnetic members held in said hollow holding portion;
said filtering device having an annular wall between said hollow holding portion and an outer wall thereof; said annular wall having an upper end below and off a top of said filtering device;
said filtering device having a flow passage existing next to inner and outer sides of said annular wall; said flow passage being stuffed with ion exchange resin; said filtering device having an inlet on an outward edge of a lower end thereof; said filtering device having an outlet on an inward edge of said lower end.

2. The filtering structure of a humidifier as recited in claim 1, wherein said filtering device has a covering part on an upper end thereof; said covering part comprising a movable part facing said hollow holding portion.
